(19) United States
(12) Patent Application Publication
(10) Pub. No.: US 2007/0166123 A1
(43) Pub. Date: Jul. 19, 2007

(54) Securing assembly for combining two adjacent elements on a bicycle

(75) Inventor: Jr-Yuan Jang, Changhua City (TW)

Correspondence Address: Troxell Law Office PLLC;Suite 1404, 5205 Leesburg Pike, Falls Church, VA, 22041, US

(73) Assignee: Lee Chi Enterprises Co., Ltd.

(21) Appl. No.: 11/333,356

(22) Filed: Jan. 18, 2006

(51) Int. Cl. F16B 39/04

(52) U.S. Cl. 411/214

(57) ABSTRACT

A securing assembly includes a threaded bolt with a passage and an inner threading formed on an inner periphery of the passage and a first threaded rod extending into and out of the passage of the threaded bolt so that the threaded bolt is able to apply a force to two combined elements in a direction opposite to that of the force exerted by the threaded rod to the two combined elements.

### BACKGROUND OF THE INVENTION

1. Field of the Invention

The present invention relates to a securing assembly for combining two adjacent elements on a bicycle, and more particularly to a securing assembly having a bolt extendable into the two adjacent elements and provided with a passage defined therethrough to allow a threaded bolt to threadingly extend into the bolt so as to abut a side face of one of the two adjacent elements such that two forces directing to two opposite directions are applied to the combined elements and thus engagement between the two adjacent elements is secured.

2. Description of the Prior Art

In a bicycle, there are various parts configured to have different designated purposes. These parts are normally secured to the frame of the bicycle or secured to each other to co-operate with one another to fulfill the task. However, parts may become loose when the bicycle is driven to run on roads of different terrain. When two adjacent parts are too loose to accomplish the designated tasks during the time when the bicycle is running on roads, rider's safety is on the edge. Therefore, different securing assemblies are provided to secure engagement between two adjacent parts on the bicycle. The most common securing assembly is shown in FIGS. 5 and 6, wherein the securing assembly is applied to secure the brake system of the bicycle. The brake system normally has a first arm (50) and a second arm (51) pivotally connected to the first arm (50) via a link (52) which is connected to the first arm (50) and the second arm (52). A brake cable (56) extends through a distal end of the first arm (50) and securely connected to a distal end of the second arm (51). The proximal ends of the first arm (50) and the second arm (51) are respectively provided with brake pads (55) so that when the brake cable (56) is pulled, the driving force from the link (52) enables the proximal end of the first arm (50) to pivot along with the pivotal movement of the proximal end of the second arm (51). The first arm (50) has a connecting rod (501) extending through a portion of the link (52) to firmly engage with a bicycle frame (not shown). To ensure that the first arm (50) and the second arm (51) are tightly secured to one another, the securing assembly includes a bolt (53) extending through a first through hole (510) defined at a joint of the first arm (50) and the second arm (51) and a second through hole (520) defined at a portion of the link (52) to engage with a nut (54). Using the threading connection between the bolt (53) and the nut (54), the first arm (50) and the second arm (51) are secured.

With reference to FIG. 7, in order to enhance the engagement between the second arm (65) and the link (63), a different securing assembly is provided and includes a bolt (60) threadingly extended through the link (63) and into the second arm (65) and two threaded rods (61, 64) respectively extended into the second arm (65) to radially and longitudinally abut a side face of the bolt (60) such that possibility of having the bolt (60) to become loose during the riding of the bicycle is greatly reduced.

With reference to FIG. 8, another different conventional securing assembly is introduced to the market to further enhance the engagement between the link (85) and the second arm (80). The securing assembly includes a threaded bolt (70), a washer (74) sandwiched between the second arm (80) and the link (85), a threaded cap (75) threadingly connected to an end of the threaded bolt (70), a first threaded rod (76) threadingly extended into the threaded cap (75) to abut the end of the threaded bolt (70) and a second threaded rod (77) threadingly extended into the second arm (80) to abut a threaded portion of the threaded bolt (70). The threaded bolt (70) is configured to have a first threaded portion (71) received in the second arm (80), a second threaded portion (72) received in the link (85) and a wing (73) formed to separate the first threaded portion (71) from the second threaded portion (72). Therefore, a free end of the threaded cap (75) abuts against a side face of the wing (73) after passing through the link (85) and the first threaded rod (76) securely abuts against an end of the threaded bolt (70) so that two opposite forces are applied to the threaded bolt (70) to position the threaded bolt (70) inside the link (85) and the second arm (80). Further, the abutment of the second threaded rod (77) to the side face of the threaded bolt (70) is to prevent the threaded bolt (70) from rotation during the riding of the bicycle.

It is noted from the result of the three conventional securing assemblies, the embodiment shown in FIG. 8 provides the most efficient securing effect to ensure that the engagement between the second arm and the link. However, the quantity of elements is large and thus the cost of manufacture is high.

To overcome the shortcomings, the present invention tends to provide an improved securing assembly to mitigate the aforementioned problems.

### SUMMARY OF THE INVENTION

The primary objective of the present invention is to provide an improved securing assembly to secure engagement between two adjacent elements on a bicycle.

In one objective of the present invention, the securing assembly of the present invention is composed of a threaded bolt threadingly extended into a blind hole defined in the second arm and having a head to abut a side face of the link, a passage defined through the threaded bolt to threadingly receive therein a threaded rod which in turn extends out of the threaded bolt to abut a side face of the blind hole in the second arm so that two forces directing to two opposite directions are applied to the threaded bolt such that engagement between the second arm and the link is secured.

In a different objective of the present invention, a second threaded rod is threadingly extended into a side face of the second arm to abut a side face of the threaded bolt to prevent rotation of the threaded bolt.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the securing assembly incorporated with the brake system of a bicycle;

FIG. 2 is a schematic cross sectional view showing the application of the first embodiment of the securing assembly of the present invention;

FIG. 3 is a schematic cross sectional view showing the application of the second embodiment of the securing assembly of the present invention;

FIG. 4 is a schematic cross sectional view showing the application of the third embodiment of the securing assembly of the present invention;

FIG. 5 is an exploded perspective view showing the conventional securing assembly incorporated with the brake system of a bicycle;

FIG. 6 is a schematic cross sectional view showing the application of the securing assembly in FIG. 5;

FIG. 7 is a schematic cross sectional view showing a different conventional securing assembly incorporated with the brake system; and

FIG. 8 is a schematic cross sectional view showing a still different conventional securing assembly incorporated with the brake system.

### DETAILED DESCRIPTION OF THE PREFERRED EMBODIMENT

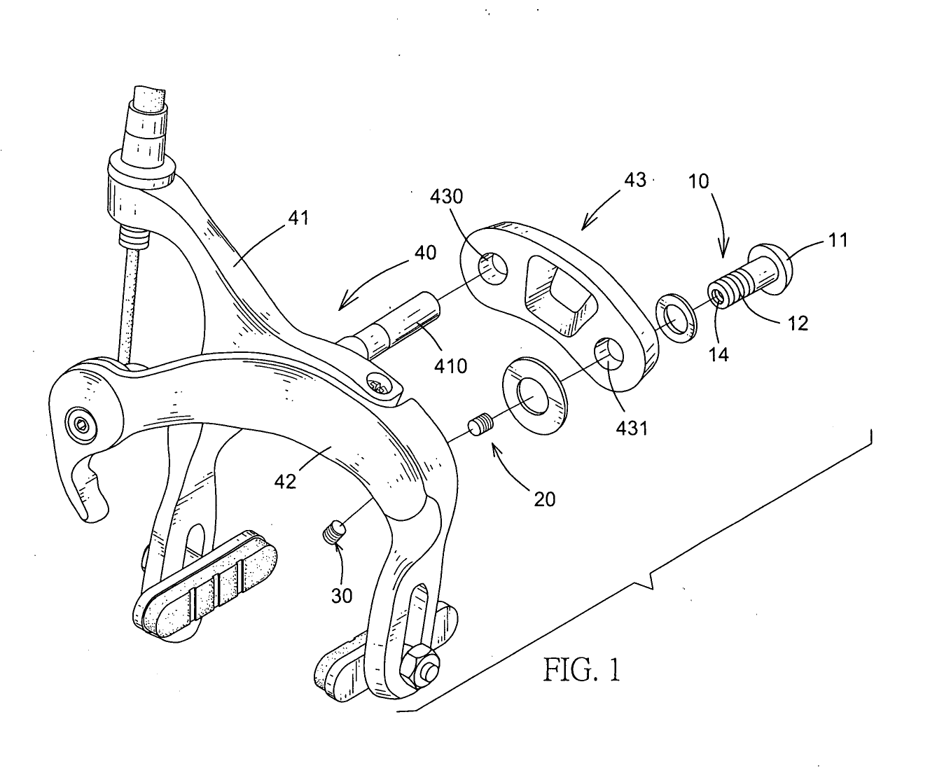

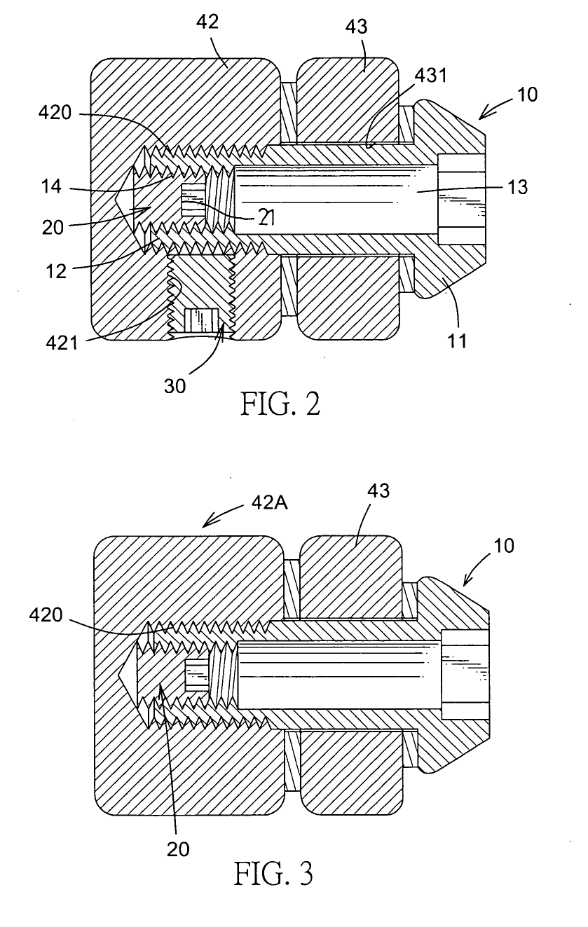

With reference to FIGS. 1 and 2, it is noted that the securing device in accordance with the present invention is applied to a brake system having a first arm (41), a second arm (42) pivotally connected to the first arm (41) and a link (43) engaged with both the first arm (41) and the second arm (42). The first arm (41) has an engaging arm (410) extending from a side face of the first arm (41) to extend through a first through hole (430) in the link (43) for firm engagement with the bicycle frame (not shown). The link (43) has a second through hole (431) defined to correspond to the securing assembly of the present invention.

The securing assembly in accordance with the present invention includes a threaded bolt (10) threadingly extended into a blind hole (420) defined in the second arm (42) and having a head (11) to abut a side face of the link (43), an outer threading (12) formed on an outer periphery of the threaded bolt (10), a passage (13) defined through the threaded bolt (10) to threadingly receive therein a first threaded rod (20) which in turn extends out of the threaded bolt (10) to abut a side face of the blind hole (420) in the second arm (42) and an inner threading (14) formed on an inner face of the passage (13).

Therefore, after the threaded bolt (10) is extended through the link (43) and threadingly extended into the blind hole (420) of the second arm (42), the first threaded bolt (20) is extended into the passage (13) to threadingly engage with the inner threading (14) and to extend out of the threaded bolt (10) to abut a bottom face defining the blind hole (420). In addition, a second threaded bolt (30) is threadingly extended from a side face of the second arm (42) to axially abut a side face of the threaded bolt (10), preferably, the outer threading (12), so that the threaded bolt (10) is prevented from rotation. After the extension of the threaded bolt (10) into the second arm (42) through the link (43), the threaded bolt (10) applies a pulling force directing toward the blind hole (420) of the second arm (42) and after the extension of the first threaded rod (20) into the passage (13) to abut the bottom face defining the blind hole (420), the first threaded rod (20) applies a pushing force directing away from the blind hole (420) to the threaded bolt (10). Therefore, under the acting of these two forces of different directions, the engagement between the second arm (42) and the link (43) is enhanced. To facilitate the extension of the first threaded bolt (20), the first threaded rod (20) is provided with a countersunk hole (21) such that the user is able to use an auxiliary tool to extend the second threaded rod (20) into and out of the threaded bolt (10) to abut the bottom face of the blind hole (420).

With reference to FIG. 3, it is noted that the addition of the second threaded rod (30) into the second arm (42) is optional and the optimum goal of the present invention can still be accomplished.

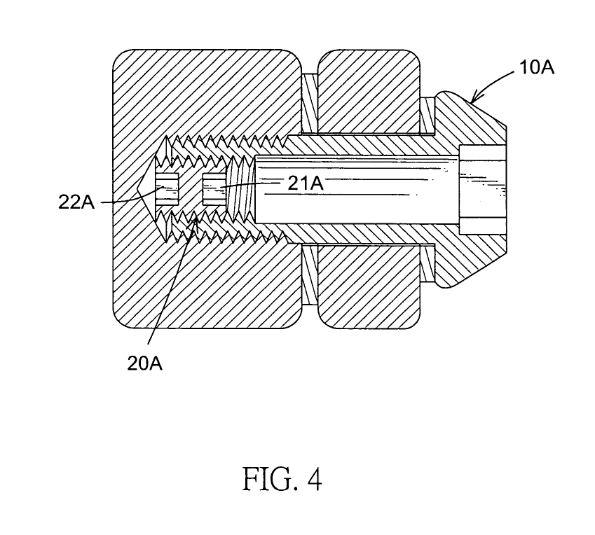

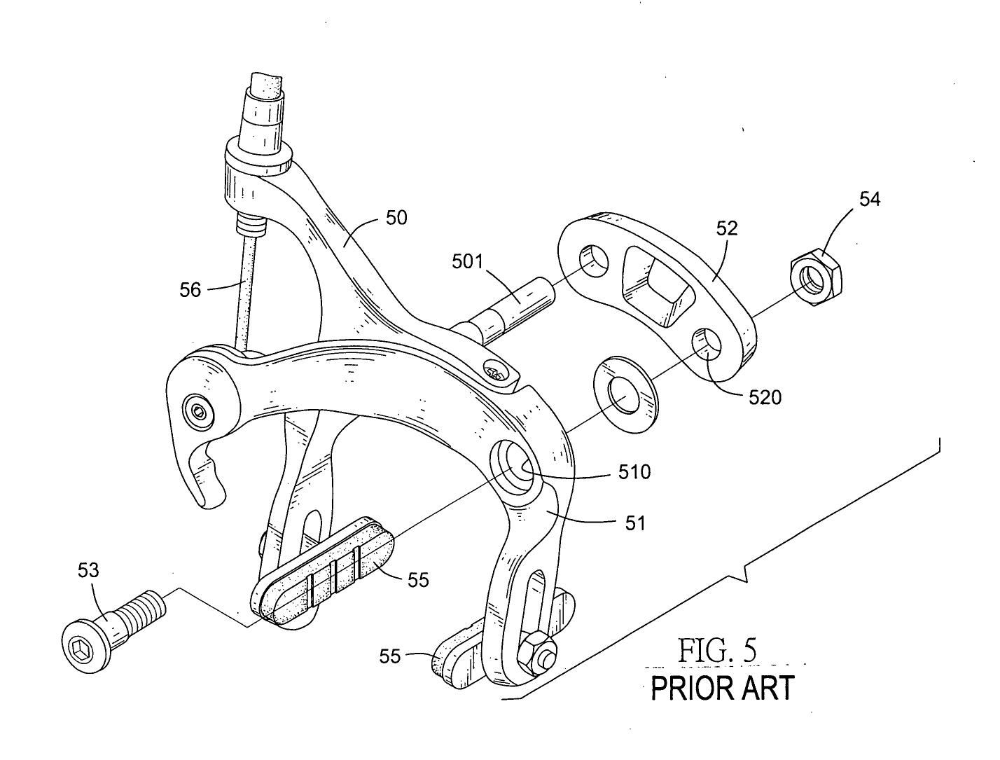

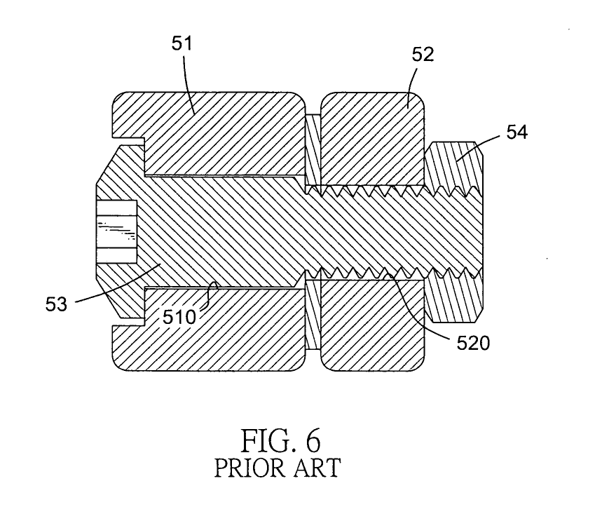

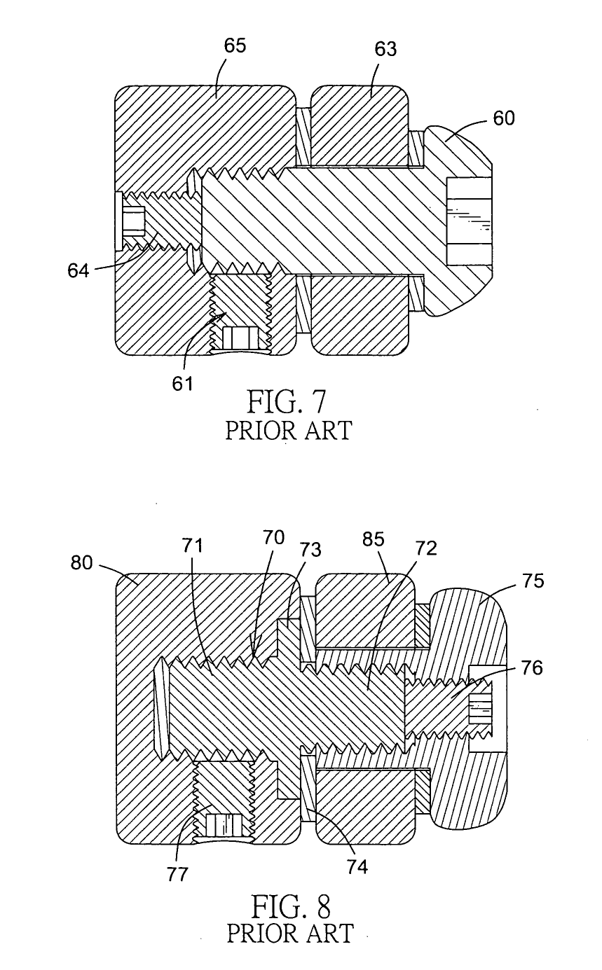

With reference to FIG. 4, it is learned that the second threaded rod (20A) is provided with two countersunk holes (21A) respectively defined in two opposite ends of the second threaded rod (20A) so that when the second threaded rod (20A) is extended into the threaded bolt (10A), the user is easy to use either one of the two countersunk holes (21A) to extend it into the threaded bolt (10A).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A bicycle braking assembly comprising:
a first arm having:
a side face; and
an engaging arm extending from the side face of the first arm;
a second arm pivotally connected to the first arm and having:
a side face; and
a blind hole defined in the side face of the second arm;
a link abutting the side faces of the first arm and the second arm and having:
a side face;
a first through hole defined in the link for the engaging arm to extend through for firm engagement with a bicycle frame; and
a second through hole defined in the link;
a threaded bolt mounted in the blind hole in the second arm and the second through hole in the link and having:
a proximal end;
a distal end;
an outer periphery;
a fixed outer diameter;
a head formed on the proximal end for abutment against the side face of the link;
a passage defined through the threaded bolt;
an outer thread formed on the outer periphery thereof so that the threaded bolt is able to screw into the second arm; and
an inner thread formed on an inner periphery defining the passage at the distal end of the threaded bolt; and
a first threaded rod extending into and out of the passage for abutment against the side face of the second arm, wherein a movement of the threaded rod provides a force to keep the threaded bolt from loosening.

2. The bicycle braking assembly as claimed in claim 1, further comprising a second threaded rod extending into the first arm to abut the outer thread of the threaded bolt to prevent the threaded bolt from rotating.

3. The bicycle braking assembly as claimed in claim 1, wherein the first threaded rod has a proximal end and a countersunk hole defined in the proximal end.

4. The bicycle braking assembly as claimed in claim 2, wherein the first threaded rod has two ends and two countersunk holes defined respectively in the two ends.
